(19) United States
(12) Patent Application Publication
(10) Pub. No.: US 2011/0302853 A1
(43) Pub. Date: Dec. 15, 2011

(54) Method for molding artistic surfaces

(76) Inventor: Mark Alan Wiwi, South Bend, IN (US)

(21) Appl. No.: 13/068,845

(22) Filed: May 4, 2010

(51) Int. Cl. E04F 17/06; B22D 23/00; B22C 9/00; B29C 41/04; B29C 41/06

(52) U.S. Cl. 52/107; 264/310; 164/6

(57) ABSTRACT

A method for molding plastic articles with artistic patterns comprises: producing an artistic surface (10) by laying up stones, or masonry (12), or by any other suitable method, conforming a curable plastic mat (16) to the artistic surface (10); and subsequently curing the curable plastic mat (16) into a cured negative (24) of the artistic surface (10). Optionally, the cured negative (24) is curved prior to making a plaster positive (38). The present invention also includes a window-well egress (90) that is more attractive because of an artistic surface (96), and is stronger by virtue of inner (92) and outer (98) walls with a space (102) therebetween, and ribs (108), or corrugations (110) on the outer wall (98).

### CROSS-REFERENCES TO RELATED APPLICATIONS

Not Applicable

### STATEMENT RE FEDERALLY SPONSORED RESEARCH OR DEVELOPMENT

Not Applicable

### REFERENCE TO “SEQUENCE LISTING”

Not Applicable

### BACKGROUND OF THE INVENTION

1. Field of the Invention

The present invention relates generally to methods for making texturized molds and molding articles with texturized surfaces. More particularly, the present invention pertains to creating artistic surfaces, making rigid or flexible negatives of the artistic surfaces, optionally curving the flexible negatives, making positives, making mold negatives with artistic surfaces, and rotomolding plastic articles with the artistic surfaces.

2. Description of the Related Art

Plastic has become an important material for making a vast array of articles in nearly every field, from toys to household goods, automobiles, home construction, highway safety, and even security barriers for public and government buildings. While injection molding and vacuum molding of plastics have important places, for larger plastic articles, rotomolding is the method of choice.

In the process of rotomolding, a mold, having two halves, is commonly made from aluminum sheets, aluminum extrusions, and/or aluminum castings. The rotomold is attached to a machine that is capable of rotating the mold around both X and Y axes, and a furnace is provided that heats the mold to the melting temperature of the selected thermoplastic.

In operation, the mold is opened, thermoplastic pellets are inserted, the mold is closed, heat is applied to the mold, and the mold is rotated about both X and Y axes until the thermoplastic is thoroughly melted, and until the inside surfaces of the rotomold are coated with the melted thermoplastic.

When the mold is opened, the molded part closely conforms to the mold in size, shape, and texture. With regard to texture, it has been common practice to sandblast or shot peen the inside of a rotomold so that the resultant texture conceals any blemish in the rotomold, conceals any blemish in the molded article, and adds to the attractiveness of the rotomolded articles.

One important use for rotomolding is making egress units for basement windows, since these units are important for fire safety. While window-well egresses have been made from poured cement, stone, brick, and corrugated steel, rotomolded plastic has been used to advantage. Van Gilst, in U.S. Pat. No. 6,713,009, which issued on Mar. 30, 2004, teaches a method in which steel ladder rungs can be rotomolded into a window-well egress.

However, for those looking out at a window well egress day after day, appearance becomes important. And rotomolding can meet this felt need. For instance, a rotomolded egress may be molded with a gray or blue-gray color that is very similar to various varieties of stone. And the rotomold may be shot peened to give the rotomolded egress a pleasing texture.

In addition to window-well egresses, rotomolding is used to mold articles that are used for containers. Rotomolded containers are used for storing and/or transporting parts in manufacturing plants, for containing water or other fluids, and for containing dry materials.

With regard to plastic containers, rotomolding is used for molding plastic barrels, that when filled with sand and placed in a row in front of a highway barricade, save lives by providing a more moderate deceleration when hit by a car than occurs when hitting a concrete structure, thereby shielding automobile occupants from deadly crashes into highway structures.

Further, rotomolding is also useful for molding articles used to conceal or disguise utilitarian objects. A home owner, whose pride is his home, is not pleased to have a transformer or a gas meter dominate his lawn and shrub decor. To meet this felt need, rotomolded replicas of rocks have been made to look like natural stones to disguise or conceal these utilitarian objects.

Large rotomolded containers, filled with sand and disposed in a row, can be used to provide highway traffic separators. But perhaps even more importantly, large rotomolded containers, filled with sand, can be placed in front of public or governmental buildings to provide security from terrorist car bombers.

In all of the above-discussed applications, and numerous others not discussed herein, the present invention provides a method for rapidly and economically making rotomolds with artistic surfaces, whereby nearly any artistic surface can be rotomolded onto nearly any rotomolded article at a reasonable cost. Therefore, considering the desire of architects to beautify everything from homes to highways, to public and governmental buildings, it can be seen that the present invention is of considerable economic significance.

### BRIEF SUMMARY OF THE INVENTION

In a preferred embodiment of the present invention, a method for making a mold comprises creating or providing an artistic surface, producing a negative of the artistic surface; producing a positive from the negative, and casting a mold negative.

Preferably, the molds are rotomolds and the articles produced thereby are rotomolded plastic, although an artistic surface may be produced onto any type of mold produced as taught herein, and any suitable type of material can be molded therein. Optionally, the step of producing a positive includes curving, or otherwise deforming, the artistic surface.

In the preferred embodiment of the present invention, a stone mason creates artistic surfaces by laying stone as if he were building a container with four sides for use as a planter or for use as a security barrier in front of a public building. That is, for a container that will have four sides, he creates four artistic surfaces by laying stones for each of the four sides so that together they show not only fronts of the stones, but also ends of the stones at each end of the four sides.

After the stone mason has finished his work, a resilient mat of curable plastic is wrapped around the four sides of the stone structure, a resilient pressure pad is wrapped around the curable mat, longitudinal pressure plates are positioned on the four sides of the stone structure, and the pressure plates are forced inwardly.

While these pressure plates may be forced inwardly by any suitable means, preferably a belt is disposed circumferentially around the pressure plates, and the belt is tightened, thereby pressing the pressure plates against the pressure mat, and thereby pressing the pressure mat into artistic transferring contact with the curable mat until the mat is cured with the image of the stone, or other artistic surface, embedded therein.

Subsequently, the cured mat, with the stone image embedded therein, is removed from the stone work, a plaster positive is made from the mat negative, aluminum negatives are cast, preferably each reflecting two sides of the stone structure, and the aluminum negatives are incorporated into a rotomold.

A first object of the present invention is to mold articles with artistic surfaces;

A second object of the present invention is to provide a method for making rotomolds with artistic surfaces;

A third object of the present invention is to provide a method for rapidly and economically including artistic surfaces in rotomolds;

A fourth object of the present invention is to mold containers, for wet and dry materials, with artistically decorated surfaces;

A fifth object of the present invention is to mold articles for concealing unsightly utilitarian articles that detract from attractive landscaping;

A sixth object of the present invention is to mold planters for general flower and shrub planting, pillars for estate entry lamps, and planters for use as flagpole bases that include artistic surfaces;

A seventh object of the present invention is to mold highway safety or crash barriers that include artistic surfaces;

An eighth object of the present invention is to mold terrorist crash barriers for public, governmental, and buildings that include artistic surfaces.

In a first aspect of the present invention, a method for making a rotomold comprises: providing an artistic surface; producing a negative of the artistic surface; producing a positive from the negative; casting a rotomold negative from the positive; and incorporating the rotomold negative into a rotomold.

In a second aspect of the present invention, a method for rotomolding articles with a structural wall comprises: molding an artistic pattern on a first surface of the wall; molding strengthening ribs on an opposite side of the wall; and preventing the ribs from printing out onto the first surface.

In a third aspect of the present invention, a method for rotomolding articles with artistic surfaces comprises: creating an artistic surface; making a flexible negative of the artistic surface; shaping the flexible negative into a shaped negative; making a shaped positive from the shaped negative; making a rotomold that includes a negative of the shaped positive; and rotomolding articles with the shaped artistic surface.

In a fourth aspect of the present invention, a method for rotomolding articles with orthogonally complementing artistic surfaces comprises: arranging masonry into orthogonally complementing artistic surfaces; making orthogonally complementing negatives of said artistic surfaces; molding orthogonally complementing positives from said negatives; casting orthogonally complementing negatives from said orthogonally complementing positives; and rotomolding a plastic article with said orthogonally complementing artistic surfaces.

In a fifth aspect of the present invention, a plastic window-well egress comprises: an inner wall; an outer wall; a space between said inner and out walls; and ribs on said outer wall.

In a six aspect of the present invention, a rotomolded structure comprises: a pair of spaced-apart walls; one the walls includes corrugations; and the other of the walls includes an artistic surface.

In a seventh aspect of the present invention, a rotomolded structure comprises: circumferentially spaced-apart inner and outer walls; one of said walls includes corrugations; and the other of said walls includes an artistic surface.

### BRIEF DESCRIPTION OF THE SEVERAL VIEWS OF THE DRAWINGS

FIG. 1 is a cross-sectional elevation showing a pressure plate pressing downward onto a pressure pad, thereby deforming a curable mat down onto an artistic masonry positive, thereby deforming the curable mat into a flexible negative of the masonry artistic pattern that is of generally uniform thickness, and that subsequently cures into a cured flexible negative of the masonry artistic pattern;

FIG. 2 is a cross-sectional elevation, taken substantially the same as FIG. 1, showing that the cured flexible negative of the positive artistic pattern of FIG. 1 and the opposite surface thereof, together, make the cured flexible negative substantially constant in thickness;

FIG. 3 is a cross-sectional elevation, taken substantially the same as FIGS. 1 and 2, showing the cured flexible negative concavely curved by a form board on the side opposite to the masonry artistic negative, and a convex plaster positive cast into the concavely curved negative;

FIG. 4 is a is a cross-sectional elevation, taken substantially the same as FIGS. 1-3, showing the aforesaid opposite side of the flexible negative of FIG. 2 concavely curved around the form board of FIG. 3, and a concave plaster mold formed against the aforesaid opposite side, and spaced apart from the aforesaid opposite side by the thickness of the flexible negative;

FIG. 5 is a is a cross-sectional elevation, taken substantially the same as FIGS. 1-4, showing a curved aluminum negative molded between the convex plaster positive of FIG. 3 and the concave plaster mold of FIG. 4;

FIG. 6 is a is a cross-sectional elevation, taken substantially the same as FIGS. 1-5, showing the curved aluminum negative with its substantially uniform thickness;

FIG. 7 is a perspective elevation, showing a rectangular, or circumferentially disposed, artistic surface developed by a stone structure laid up by a stone mason, a curable mat disposed circumferentially thereabout, a pressure pad disposed circumferentially over the curable mat, four pressure plates (one shown) disposed over the pressure pad, and a circumferential tightening belt disposed around the four pressure plates;

FIG. 8 is a perspective elevation of a double-wall basement window egress that includes a brick texture made by a method of the present invention, taken somewhat from above and somewhat to one side;

FIG. 9 is a perspective elevation of the double-wall basement window egress of FIG. 8, also taken somewhat from above, again showing some of the inner wall brick texture, but primarily showing a side and rear thereof with bracing of the outer wall; and

FIG. 10 is a partial cross section of the basement window egress of FIGS. 8 and 9, taken substantially as shown by cross-section line 10-10 of FIG. 8, showing an inner and an outer wall separated by an air space, and also showing ribs, or corrugations, on the outer wall.

### DETAILED DESCRIPTION OF THE INVENTION

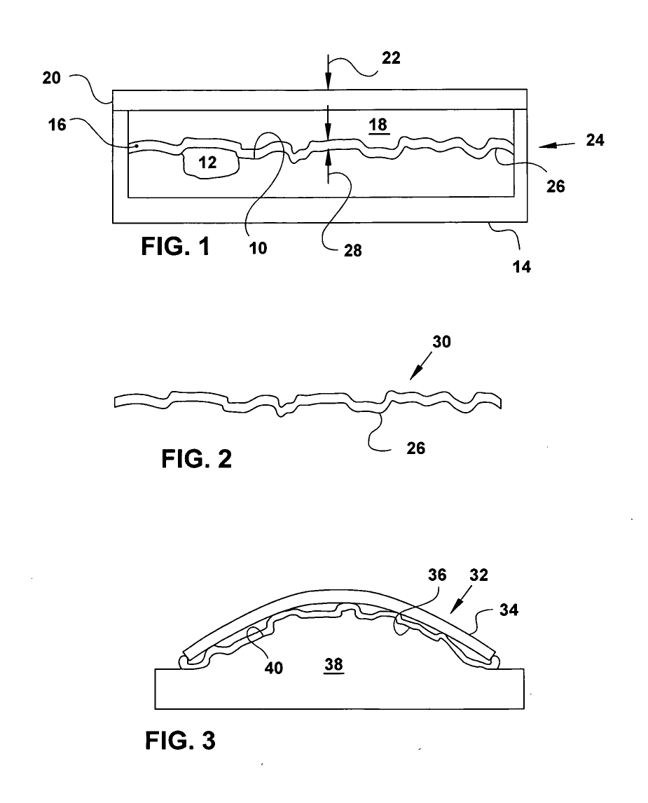

Referring now to FIG. 1, an artistic surface, or artistic masonry surface, 10 is created by arranging stones, or masonry, 12 in a masonry box 14. A curable plastic mat 16 is placed over the artistic surface 10, a resilient pressure pad 18 is disposed over the curable plastic mat 16, and a rigid pressure plate 20 is disposed over the resilient pressure pad 18. A force 22 forces the pressure plate 20 downward, pressing the resilient pressure pad 18 against the curable plastic mat 16, thereby transforming the curable plastic mat 16 into a flexible negative 24 of the artistic surface 10 that includes a negative artistic surface 26, and that is of generally uniform thickness 28.

Referring now to FIGS. 1 and 2, while retaining the force 22 on the pressure pad 18 and the plastic mat 16, as shown in FIG. 1, the curable plastic mat 16 self-cures into a cured flexible negative 30 with the negative artistic surface 26, as shown in FIG. 2.

Referring now to FIG. 3, the cured flexible negative 30 of FIG. 2 is curved into a concave curved negative 32 of FIG. 3 by means of a curving board 34, so that the concave curved negative 32 includes a concave negative surface 36. A convex plaster positive 38 is cast into the concave negative 32, so that the convex plaster positive 38 includes a convex curved positive surface 40 that corresponds to the artistic surface 10 of FIG. 1.

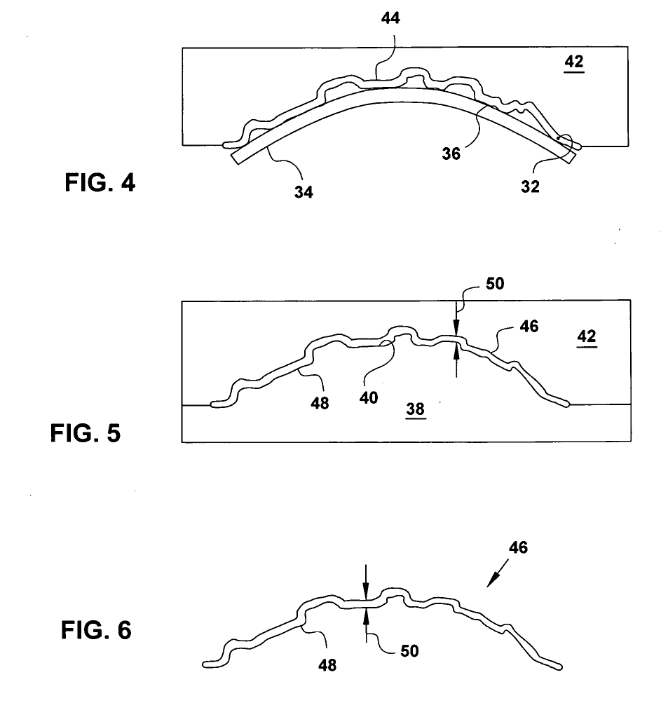

Referring now to FIG. 4, the curving and molding process is repeated, again using the curving board 34, but this time a plaster mold 42 is formed from a side 44 of the concave cured negative 32 that is opposite to, and spaced apart from, the concave negative surface 36.

As shown in FIG. 5, the plaster mold 42 of FIG. 4 is juxtaposed on top of the plaster positive 38 of FIG. 3, and an aluminum negative 46 is cast therebetween. The aluminum negative 46, of FIGS. 5 and 6, includes a concave negative surface 48 that negatively corresponds to the convex positive surface 40 of the plaster positive 38, and a thickness 50 that corresponds to the thickness 28 of FIG. 1. Thus the aluminum negative 46, with its uniform thickness, is readily adaptable to use into a rotomold.

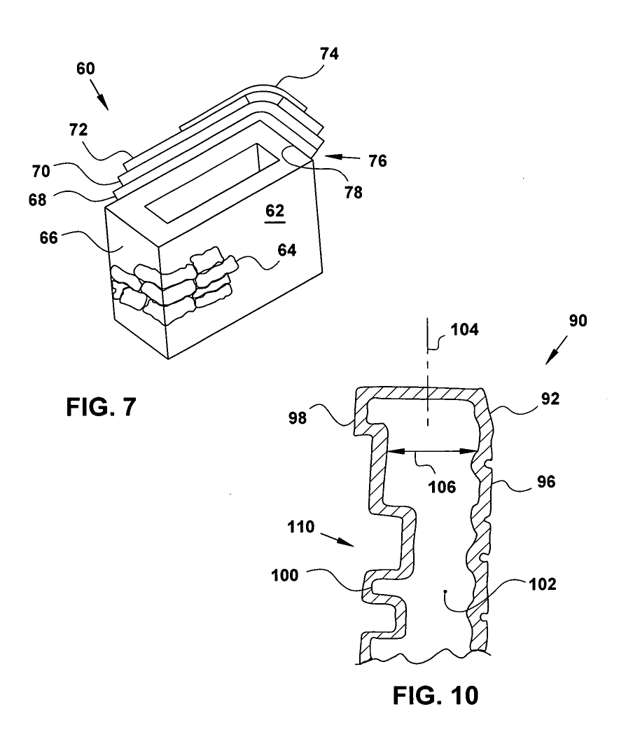

Referring now to FIG. 7, a rectangular masonry structure 60 includes sides 62 made of stones, or masonry 64, thereby providing a continuous artistic surface 66 that is disposed circumferentially around the rectangular masonry structure 60. A curable mat 68 is disposed circumferentially around the masonry structure 60, a pressure pad 70 is disposed circumferentially over the curable mat 68, and four pressure boards 72 (two shown) are disposed over respective ones of the sides 62, and a circumferential belt 74 is disposed over the boards 72.

In operation, tightening the circumferential belt 74 results in the four pressure boards 72 being pressed inwardly against the circumferential pressure pad 70 which, in turn, results in the curable mat 68 being pressed inwardly against the continuous artistic surface 66, so that a circumferential, or four sided, negative 76 is formed that, when cured, provides four circumferentially continuous negatives surfaces 78.

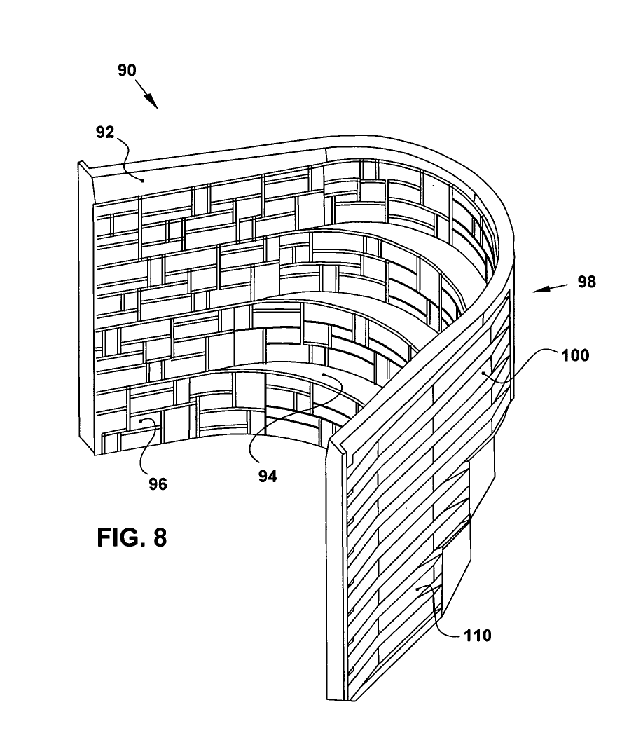

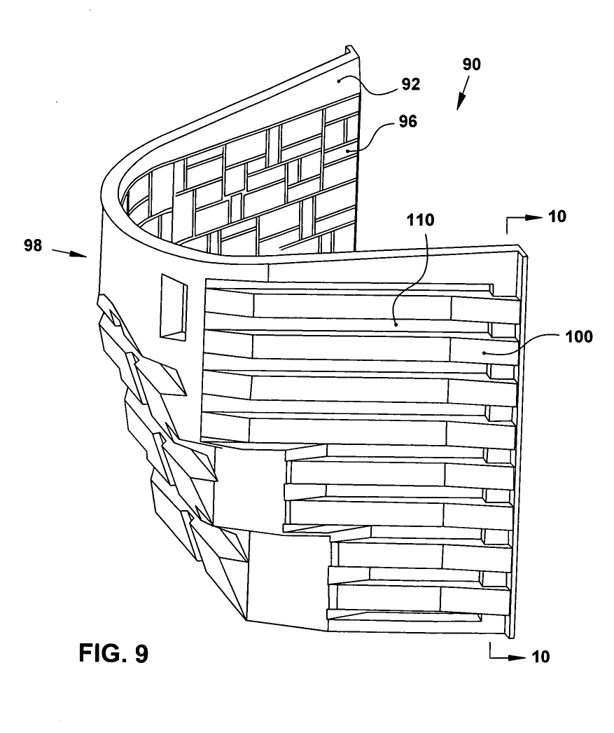

Referring now to FIGS. 8-10, a window-well egress 90 includes a front wall, or inner wall 92 with steps 94 (shown only in FIG. 8), an artistic surface 96, and an outer wall 98 with ribs or bracing 100.

In addition to providing a method for molding the window-well egress 90 with an artistic inner surface, such as the artistic surface 96, the present invention achieves greater strength than previous rotomolded window-well egresses.

More particularly, the egress 90 of the present invention achieves greater strength by virtue of an inner wall 92 and outer wall 98 that are separated by an air space 102 as shown in FIG. 10. Therefore, the moment of inertia about any axis in a plane 104 of FIG. 10 is increased as a function of the cube of a distance 106 between the inner wall 92 and the outer wall 98.

In addition, greater strength is achieved by incorporation of ribs 108 on the outer wall 98 that are larger than could be molded onto the rear of a single-wall egress without an image of the ribs 108 “printing through” the inner wall 92, and thereby damaging the artistic surface 96 of FIGS. 8-10.

Further, because of the air space 102 that separates the inner wall 92 from the outer wall 98, instead of forming the ribs 108, it is possible to form corrugations 110 that depend into the air space 102 and extend outwardly from the outer wall 98, so that the corrugations 110 help to achieve a strength/weight ratio that would be impossible to achieve by use of the ribs 108.

In summary, the present invention provides a method for both rapidly and economically making rotomolds with nearly any desired artistic surface, or surfaces, so that articles that otherwise are visually boring, if not visually offensive, become artistically pleasing.

Further, as discussed above, rotomolded articles with artistic surfaces made by the method of the present invention, range from utilitarian articles, to articles that cover unsightly articles, to articles that enhance fire safety, as in the window-well egress of the present invention, to articles that enhance highway safety by providing crash barriers, and to articles that provide protection from terrorist bombers around public and governmental buildings.

Finally, the present invention provides a method rotomolding articles with an improved strength-weight ratio in addition to providing a method for making rotomolds with nearly any desired artistic surfaces.

While specific apparatus and method have been disclosed in the preceding description, it should be understood that these specifics have been given for the purpose of disclosing the principles of the present invention, and that many variations thereof will become apparent to those who are versed in the art.

What is claimed is:

1. A method for making a rotomold which comprises:
a) providing an artistic surface;
b) producing a negative of said artistic surface;
c) producing a positive from said negative;
d) casting a rotomold negative from said positive; and
e) incorporating said rotomold negative into a rotomold.

2. The method claimed in claim 1 in which said providing step comprises creating said artistic surface.

3. The method claimed in claim 1 in which:
a) said providing step comprises creating said artistic surface; and
b) said creating step comprises selecting and arranging a plurality of articles.

4. The method claimed in claim 1 in which:
a) said providing step comprises creating said artistic surface; and
b) said creating step comprises selecting and arranging masonry.

5. The method claimed in claim 1 in which said step of producing a negative of said artistic surface comprises conforming a resilient sheet to said artistic surface.

6. The method claimed in claim 1 in which said step of producing a negative of said artistic surface comprises:
a) conforming a resilient sheet to said artistic Surface; and
b) curing said conforming sheet into said negative of said artistic surface.

7. The method claimed in claim 1 in which:
a) said step of producing a negative of said artistic surface comprises conforming a resilient sheet to said artistic surface; and
b) said conforming step comprises producing an opposite complementary surface.

8. The method claimed in claim 1 in which said step of producing a negative of said artistic surface comprises producing a sheet of substantially uniform thickness.

9. The method claimed in claim 1 in which said step of producing a negative of said artistic surface comprises producing a sheet of substantially uniform thickness with an opposite complementary surface.

10. The method claimed in claim 1 in which said casting step comprises producing an aluminum negative that is of substantially uniform thickness.

11. (canceled)

12. The method claimed in Claim 1 in which said method further comprises conforming said negative to a desired shape prior to said step of producing a positive, without substantially distorting said artistic surface.

13. (canceled)

14. (canceled)

15. (canceled)

16. The method claimed in claim 1 in which said producing step comprises producing a circumferential artistic surface.

17. The method claimed in claim 1 in which said providing step comprises selecting and arranging masonry into a circumferentially artistic pattern.

18. The method claimed in claim 1 in which:
a) said providing step comprises selecting and arranging masonry into a circumferentially artistic pattern that includes four planes;
b) said step of producing said negative comprises circumferentially enclosing said artistic pattern with a resilient sheet, resiliently conforming said sheet to said artistic surface, and curing said conforming sheet.

19. A method for rotomolding plastic articles with a structural wall which comprises:
a) molding an artistic pattern on a first surface of said wall;
c) molding strengthening ribs on an opposite side of said wall; and
d) preventing said ribs from printing out onto said first surface.

20. The method claimed in claim 19 in which said preventing step comprises separating said first and opposite surfaces with an open space therebetween.

21. (canceled)

22. (canceled)

23. A plastic window-well egress which comprises:
an inner wall;
an outer wall; .
a space between said inner and out walls; and
ribs on said outer wall.

24. The window-well egress as claimed in claim 23 in which said ribs comprise corrugations.

25. The window-well egress as claimed in claim 23 in which said window-well egress, with said artistic decoration, is rotomolded.

26. (canceled)

27. (canceled)
